(19) United States
(12) Patent Application Publication
(10) Pub. No.: US 2014/0149419 A1
(43) Pub. Date: May 29, 2014

(54) COMPLEX EVENT PROCESSING APPARATUS FOR REFERRING TO TABLE WITHIN EXTERNAL DATABASE AS EXTERNAL REFERENCE OBJECT

(71) Applicant: Altibase Corp., Seoul (KR)

(72) Inventors: Young Hun Kim, Bucheon-si (KR); Jong Heon Park, Seoul (KR); Joon Ho Park, Seoul (KR)

(73) Assignee: Altibase Corp., Seoul (KR)

(21) Appl. No.: 14/085,621

(22) Filed: Nov. 20, 2013

(30) Foreign Application Priority Data
Nov. 29, 2012 (KR) 10-2012-0137342
Oct. 14, 2013 (KR) 10-2013-0122185

(51) Int. Cl. G06F 17/30

(52) U.S. Cl. CPC G06F 17/30705; G06F 17/30634
USPC 707/740

(57) ABSTRACT

Provided is a complex event processing apparatus referring to a table within an external database as an external reference object. The complex event processing apparatus includes a query language analysis unit; a meta information management unit; a query language generation unit; a query language storage unit; and an external interface unit.

### RELATED APPLICATIONS

This application claims the benefit of Korean Patent Application No. 10-2012-0137342, filed on Nov. 29, 2012, and Korean Patent Application No. 10-2013-0122185, filed on Oct. 14, 2013, in the Korean Intellectual Property Office, the disclosures of which are incorporated herein in their entirety by reference.

### BACKGROUND

1. Field

One or more embodiments of the present invention relate to a complex event processing apparatus, and more particularly, to a method of using a table within an external database in a complex event processing apparatus.

2. Description of the Related Art

In order to perform various analysis and detection processes on consecutive events in a complex event processing apparatus, static data of a database is required to be continuously referred to. However, when a table within a database is continuously referred to and changed through inter-process communication (IPC) such as TCP/IP, performance degradation may occur.

In order to solve the performance degradation occurring in IPC, a method of storing a database in a complex event processing apparatus may be used. However, in such an in-process method, there is a problem that the database may not support a plurality of clients.

Korean Patent Application Publication No. 10-2013-0033708 is an example of the related art.

### SUMMARY

One or more embodiments of the present invention include a complex event processing apparatus using a stream as an internal object and a table of an external database as an external reference object which are combined with each other.

Additional aspects will be set forth in part in the description which follows and, in part, will be apparent from the description, or may be learned by practice of the presented embodiments.

According to one or more embodiments of the present invention, a complex event processing apparatus referring to a table within an external database as an external reference object, wherein the apparatus includes: a query language analysis unit for analyzing a continuous query language (CQL) query statement that is input to the complex event processing apparatus and then generating a parse tree; a meta information management unit for categorizing objects usable in the complex event processing apparatus as internal objects and external reference objects, managing the categorized objects as meta information, and categorizing data source objects included in the generated parse tree as the internal objects and the external reference objects by using the meta information; a query language generation unit for generating an external database query language by using the external reference objects; a query language storage unit for storing the input CQL query statement and the generated external database query language by using the input CQL query statement as a key and by using the generated external database query language as a value; and an external interface unit for executing the stored external database query language upon retrieval of the stored external database query language.

The query language analysis unit: determines whether the input CQL query statement is identical to one of CQL query statements that are currently stored in the query language storage unit, and retrieves an external database query language stored in the query language storage unit when it is determined that the input CQL query statement is identical to one of CQL query statements, wherein the retrieved external database query language corresponds to the one of the CQL query statements which the input CQL query statement is identical to, and then executes the retrieved database query language through the external interface unit.

The query language storage unit is configured to function as a cache, wherein a key of the cache includes the input CQL query statement.

A value of the cache may be the generated external database query language.

### BRIEF DESCRIPTION OF THE DRAWINGS

These and/or other aspects will become apparent and more readily appreciated from the following description of the embodiments, taken in conjunction with the accompanying drawings in which:

FIG. 1 is an internal configuration diagram of a complex event processing apparatus according to an embodiment of the present invention;

FIG. 2 illustrates an example in which the complex event processing apparatus receives a CQL query statement and then converts the CQL query statement into a parse tree, according to an embodiment of the present invention; and

FIG. 3 illustrates an example in which a metadata unit manages an external database table as an external reference object, according to an embodiment of the present invention.

### DETAILED DESCRIPTION

Hereinafter, embodiments of the present invention will be described more fully with reference to the accompanying drawings. The detailed description and the drawings are introduced to provide an understanding of the present invention, and thus, detailed descriptions of well-known technologies may be omitted. In addition, the specification and the drawing are not provided to limit the scope of the present invention and the scope of the present invention is defined by claims. The terms used herein are for the purpose of properly describing the embodiments of the present invention, and thus, may be interpreted as corresponding to the meaning and concept of the present invention.

An embodiment of the present invention provides a method of referring to a table within an external database as an external reference object in a complex event processing apparatus.

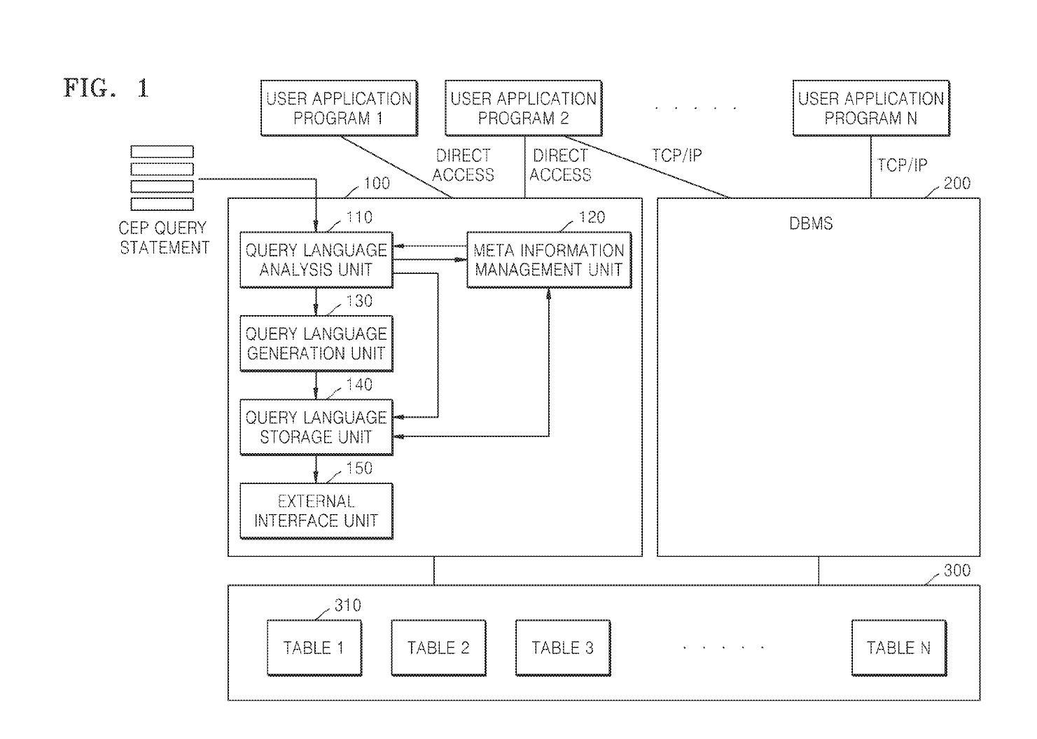

Referring to FIG. 1, an external database 200 may store tables in a shared memory 300 so that the tables, which are stored in the shared memory 300 of the external database 200, may be referred to as external reference objects within a complex event processing apparatus 100.

The complex event processing apparatus 100 retrieves meaningful data in real time with respect to events occurring in various event sources, and performs an action corresponding to the meaningful data. Examples of event data may include real-time data, data that is continuously input in large quantities, data having an important time sequence, and the like.

As an embodiment of the present invention, the external database 200, which is an apparatus for processing and storing static data, is an apparatus for managing data in table units.

Referring to FIG. 1, the complex event processing apparatus 100 includes a query language analysis unit 110, a meta information management unit 120, a query language generation unit 130, a query language storage unit 140, and an external interface unit 150.

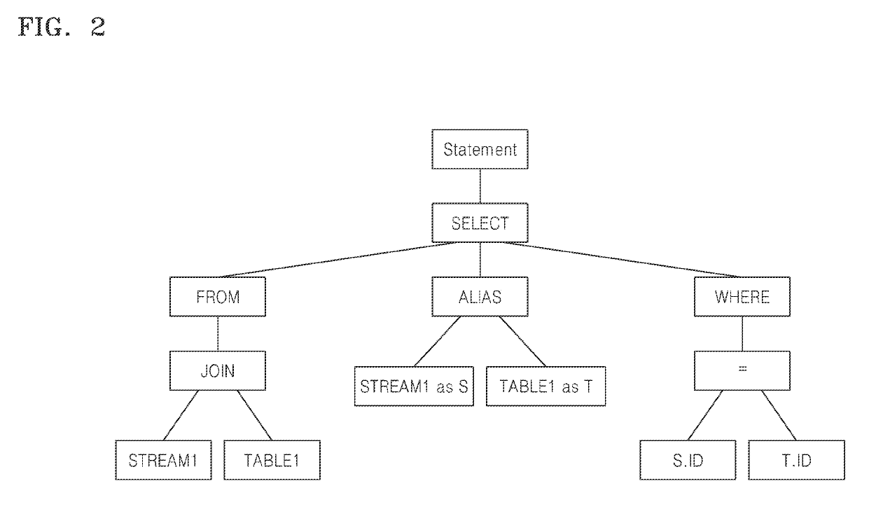

The query language analysis unit 110 analyzes a continuous query language (CQL) statement input to the complex event processing apparatus 100, and then generates a parse tree in the form illustrated in FIG. 2. FIG. 2 illustrates an example in which the query language analysis unit 110 receives a CQL query statement (S100) as described below and then converts the CQL query statement into a parse tree.

“SELECT*FROM STREAM1 AS S, TABLE1 AS T WHERE S.ID=T.ID;”(S100)

The above CQL query statement (S100) shows an example in which a JOIN operation is performed on a Table1 310, such as a table within the external database 200, and a stream Stream1, such as an internal object.

Thereafter, the complex event processing apparatus 100 divides data source objects included in a parse tree generated with reference to the meta information management unit 120 into internal objects and external reference objects. A stream object is an example of the internal object. External reference object information includes a name of the table of the external database, column information required for the table, and the like.

The query language generation unit 130 generates an external database query language on the basis of separated table object information. The query language generation unit 130 generates an external database query language as described below with respect to the received CQL query statement (S100) “SELECT*FROM STREAM1 AS S, TABLE1 AS T WHERE S.ID=T.ID;”.

“SELECT*FROM TABLE1 WHERE TABLE1.ID=?;”

The query language storage unit 140 generates the CQL query statement as a key and the external database query language as a value, and stores the key and the value as a pair. In the current embodiment, the external database query language generated by the query language generation unit 130 is generated with respect to an external database table, and has a high reuse possibility.

In the current embodiment, the query language storage unit 140 within the complex event processing apparatus 100 stores the external database query language, and thus there is an advantage in that a process of generating the external database query language by the query language generation unit 130 with respect to the same input CQL query statement may be performed only once without being repeatedly performed.

In the current embodiment, the query language storage unit 140 may function as a cache. In this case, a key of the cache basically includes the input CQL query statement. A value of the cache serves as the external database query language generated by the query language generation unit 130.

In the current embodiment, when a query is performed through the external interface unit 150 by retrieving the external database query language stored in the query language storage unit 140, the external interface unit 150 may directly access data included in the tables 310 that are managed by the shared memory 300 of the external database 200.

The query language analysis unit 110 determines whether the input CQL query statement is identical to one of CQL query statements that are currently stored in the language storage unit 140.

When it is determined that the input CQL query statement is identical to one of CQL query statements , the query language analysis unit 110 retrieves the external database query language stored in the query language storage unit 140, and then executes the retrieved external database query language through the external interface unit 150.

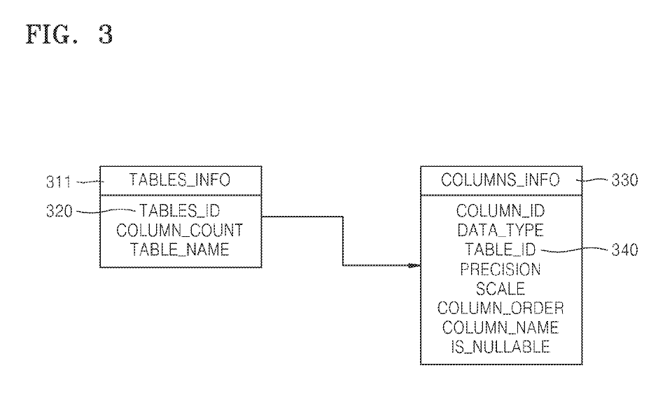

The meta information management unit 120 manages an internal object and an external reference object as illustrated in FIG. 3, and management information of the external reference object includes information regarding a number of tables of the external database, table information of the external database, and information regarding a column constituting the table of the external database.

Referring to FIG. 3, the meta information management unit 120 associates a TABLE_ID 320 of a TABLES_INFO 311 with a primary key, and associates a TABLE_ID 340 of a COLUMN_INFO 330 with a foreign key.

In the current embodiment, in order for the complex event processing apparatus 100 to use the table of the external database as an external reference object, information regarding the external reference object is required to be registered in the meta information management unit 120 in advance. In addition, the meta information management unit 120 verifies and updates information of the external reference object at the time of initialization of the complex event processing apparatus 100 or when a run-time error occurs in the complex event processing apparatus 100.

In the current embodiment, the meta information management unit 120 is configured to verify information regarding the external database table at the time of initialization of the complex event processing apparatus 100.

The meta information management unit 120 reads out the external database table managed as an external reference object and column information at the time of initialization of the complex event processing apparatus 100. Thereafter, it is determined whether the information managed by the external reference object of the complex event processing apparatus 100 is consistent with the read-out external database table and column information.

When it determined that the information managed by the external reference object of the complex event processing apparatus 100 is consistent with the readout of the external database table and column information, the initialization of the complex event processing apparatus 100 is completed. When it determined that the information managed by the external reference object of the complex event processing apparatus 100 is not consistent with the readout of the external database table and column information, the external reference object is updated using the external database table and column information which are read out by the meta information management unit 120. Thus, the complex event processing apparatus 100 may maintain table information of the latest external database as an external reference object at the time of the initialization of the complex event processing apparatus 100.

According to another embodiment of the present invention, a meta information management unit 120 is configured to verify and update information managed by an external reference object when a run-time error occurs in a complex event processing apparatus 100.

When a table of an external database 200 is changed, table information managed by the meta information management unit 120 is different from the table of the external database 200. As a result, when the complex event processing apparatus 100 executes a command on the external database on the basis of existing external reference object information, an error message such as “no corresponding table” or “erroneous column type is used” is returned from the external database.

When the meta information management unit 120 senses the above-mentioned run-time error, the meta information management unit 120 updates information managed by the external reference object.

As described above, according to the one or more of the above embodiments of the present invention, a complex event processing apparatus uses a stream as an internal object and a table of an external database as an external reference object which are combined with each other in an input CQL query statement. Thus, the complex event processing apparatus may access the table within the external database so as to refer to or change data of the table.

The present invention can also be embodied as processor readable code on a processor readable recording medium. The processor readable recording medium is any data storage device that can store data which can be thereafter read by a computer system. Examples of the processor readable recording medium include read-only memory (ROM), random-access memory (RAM), CD-ROMs, magnetic tapes, floppy disks, optical data storage devices, and flash memory. The processor readable recording medium can also be distributed over network coupled computer systems so that the processor readable code is stored and executed in a distributed fashion.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A complex event processing apparatus referring to a table within an external database as an external reference object, the apparatus comprising:
a query language analysis unit for analyzing a continuous query language (CQL) query statement that is input to the complex event processing apparatus and then generating a parse tree;
a meta information management unit for categorizing objects usable in the complex event processing apparatus as internal objects and external reference objects, managing the categorized objects as meta information, and categorizing data source objects comprised in the generated parse tree as the internal objects and the external reference objects by using the meta information;
a query language generation unit for generating an external database query language by using the external reference objects;
a query language storage unit for storing the input CQL query statement and the generated external database query language by using the input CQL query statement as a key and by using the generated external database query language as a value; and
an external interface unit for executing the stored external database query language upon retrieval of the stored external database query language.

2. The complex event processing apparatus of claim 1, wherein the query language analysis unit:
determines whether the input CQL query statement is identical to one of CQL query statements that are currently stored in the query language storage unit, and
retrieves an external database query language stored in the query language storage unit when it is determined that the input CQL query statement is identical to one of CQL query statements, wherein the retrieved external database query language corresponds to the one of the CQL query statements which the input CQL query statement is identical to, and then
executes the retrieved database query language through the external interface unit.

3. The complex event processing apparatus of claim 1, wherein the query language storage unit is configured to function as a cache, wherein a key of the cache comprises the input CQL query statement.

4. The complex event processing apparatus of claim 3, wherein a value of the cache is the generated external database query language.

5. The complex event processing apparatus of claim 1, wherein the external database stores table data in a shared memory.

6. The complex event processing apparatus of claim 5, wherein the external interface unit directly accesses the table data stored in the shared memory.

7. The complex event processing apparatus of claim 1, wherein the meta information management unit reads out an external database table managed as the external reference object and column information at upon initialization of the complex event processing apparatus.

8. A method of referring to a table within an external database as an external reference object by a complex event processing apparatus, the method comprising:
analyzing a continuous query language (hereinafter, referred to as CQL) query statement that is input to the complex event processing apparatus and then generating a parse tree;
categorizing objects usable in the complex event processing apparatus as internal objects and external reference objects, managing the categorized objects as meta information, and categorizing data source objects comprised in the generated parse tree as the internal objects and the external reference objects by using the meta information;
generating an external database query language by using the external reference objects;
storing the input CQL query statement and the generated external database query language by using the input CQL query statement as a key and by using the generated external database query language as a value; and
when the stored external database query language is retrieved, executing the stored external database query language upon retrieval of the stored external database query language.
